(19) United States
(12) Patent Application Publication
(10) Pub. No.: US 2008/0172136 A1
(43) Pub. Date: Jul. 17, 2008

(54) Operation monitor

(75) Inventor: Norikatsu Kataoka, Musashino-shi (JP)

Correspondence Address: Edwards Angell Palmer & Dodge LLP, P. O. Box 55874, Boston, MA, 02205, US

(73) Assignee: Yokogawa Electric Corporation, Tokyo (JP)

(21) Appl. No.: 12/008,058

(22) Filed: Jan. 8, 2008

(30) Foreign Application Priority Data
Jan. 11, 2007 (JP) 2007-003068

(51) Int. Cl. G05B 15/00

(52) U.S. Cl. 700/83

(57) ABSTRACT

An operation monitor for performing control operation and monitoring of a plant through an operation monitor screen includes a transparent sheet display section for superposing a transparent sheet and entered information thereon for display on the operation monitor screen and storage sections for retaining an operation monitor screen file, an entered information file, and correspondence information between the operation monitor screen file and the entered information file.

This application claims priority from Japanese Patent Application No. 2007-003068, filed Jan. 11, 2007, in the Japanese Patent Office. The Japanese Patent Application No. 2007-003068 is incorporated by reference in its entirety.

### TECHNICAL FIELD

The present disclosure relates to an operation monitor for performing control operation and monitoring of a plant. More specifically, the present disclosure relates to provide an operation monitor screen with a sophisticated function.

### RELATED ART

Hitherto, a production control system called a distributed control system for performing control operation and monitoring of a plant using a display has been available. In such a distributed control system, various pieces of information required for control operation and monitoring of a plant are displayed on a display screen and when an anomaly occurs in the plant, occurrence of the anomaly is displayed as an alarm for the operator, enabling the operator to give an appropriate command and take steps for the anomaly.

FIG. 4 is a block diagram to show the configuration of a distributed control system in a related art. A schedule creation apparatus 1 creates a batch processing schedule, for example, and sends schedule information through a communication bus BS1 to an operation monitor 2. The operation monitor 2 creates an execution prescription of the batch processing based on the schedule information sent from the schedule creation apparatus 1 and starts the batch processing. When the batch processing is started from the operation monitor 2 through a communication bus BS2, a control unit 3 causes a plant 4 to execute the batch processing in accordance with the execution prescription.

FIG. 5 is a schematic representation to show the use situation of an operation monitor in a related art. An operator who monitors operation of a factory displays a screen responsive to the monitor range and the monitor purpose on an operation monitor console 2a forming an operation monitor 2 of a terminal of a production control system, and performs operation. The screen displayed at this time (which will be hereinafter called operation monitor screen) includes only a function of simply displaying control information. Thus, information at the operation time, namely, information of a matter noted at the operation time, a matter taken over to the next worker, a situation record item and an action record item at the trouble time, etc., is operated using paper 3 and a whiteboard 4 aside from the operation monitor screen.

A related art document relevant to the production control system using the operation monitor is as follows:

[Patent document 1] Japanese Patent Unexamined Publication No. 9-128003

According to the operation monitor at the related art as described above, the record information at the operation time is separated from the operation monitor screen and thus the following problems occur:

(1) The operator must associate the record information and the operation monitor screen with each other;
(2) Since the record information and the operation monitor screen are separated, there is a fear of occurrence of a communication mistake;
(3) Since the record information and the operation monitor screen are separated, it is not possible to use in an intuitive manner;
(4) To operate information with paper, there is a fear of loss; and
(5) To operate information with paper, the information is hard to reuse.

### SUMMARY

Exemplary embodiments of the present invention provide an operation monitor capable of:

(1) associating an operation monitor screen and information at the operation time with each other;
(2) presenting the operation monitor screen and the information at the operation time associated with the operation monitor screen reliably for the operator without omission;
(3) enabling the operator to enter and view information in an intuitive manner;
(4) eliminating loss of information; and
(5) reusing information.

An operation monitor according to a first aspect of the present invention is an operation monitor for performing control operation and monitoring of a plant through an operation monitor screen, the operation monitor including:

a transparent sheet display section for superposing and displaying a transparent sheet and entered information entered on the transparent sheet on the operation monitor screen; and

a storage section for retaining an operation monitor screen file, an entered information file, and correspondence information between the operation monitor screen file and the entered information file.

An operation monitor according to a second aspect of the present invention is characterized by the fact that the operation monitor of the first aspect further includes a screen management section for sending the entered information file corresponding to the operation monitor screen file based on the correspondence information to the transparent sheet display section.

An operation monitor according to a third aspect of the present invention is characterized by the fact that in the operation monitor of the first aspect, the correspondence information is a correspondence table between the entered information file and the operation monitor screen file.

An operation monitor according to a fourth aspect of the present invention is characterized by the fact that in the operation monitor of the first aspect, when information is not entered in the transparent sheet, operation of an operator acts on the operation monitor screen.

An operation monitor according to a fifth aspect of the present invention is characterized by the fact that in the operation monitor of the first aspect, the entered information is at least any of a character string, pattern information, or link information.

As seen from the description given above, according to the present invention, the operation monitor for performing control operation and monitoring of a plant through the operation monitor screen includes the transparent sheet display section for superposing and displaying the transparent sheet and the entered information thereon on the operation monitor screen and the storage section for retaining the operation monitor screen file, the entered information file, and the correspondence information between the operation monitor screen file and the entered information file, so that the record information at the operation time is associated with the operation monitor screen in one piece.

Other features and advantages may be apparent from the following detailed description, the accompanying drawings and the claims.

### BRIEF DESCRIPTION OF THE DRAWINGS

In the accompanying drawings:

FIG. 1 is a schematic representation to show a configuration image of a screen 200 in one example of an operation monitor according to an embodiment of the present invention;

FIG. 2 is a block diagram to show a configuration example of the operation monitor according to the embodiment of the present invention;

FIG. 3 is a flowchart to show a display procedure of the screen 200;

FIG. 4 is a block diagram to show the configuration of a distributed control system in a related art; and

FIG. 5 is a schematic representation to show the use situation of an operation monitor in a related art.

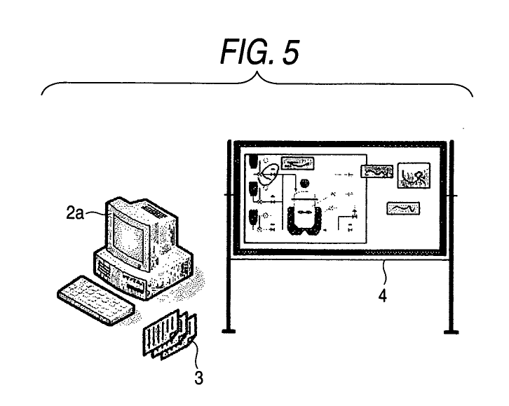

### DETAILED DESCRIPTION

An embodiment of the present invention will be discussed in detail with reference to the accompanying drawings.

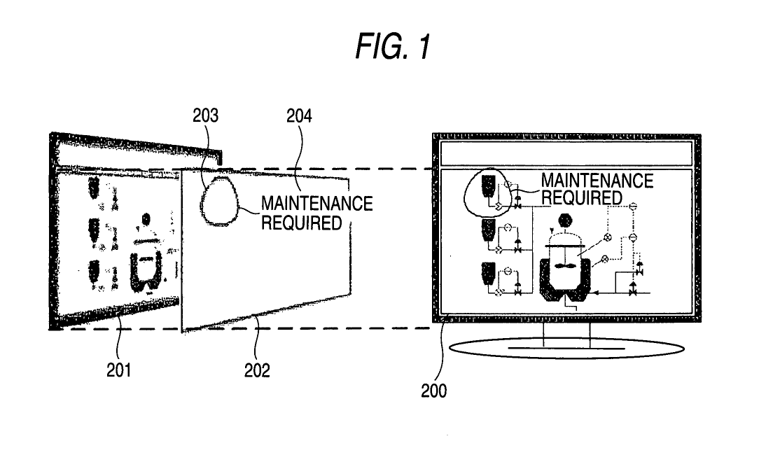

FIG. 1 is a schematic representation to show a configuration image of a display screen according to one example of an operation monitor 2 according to an embodiment of the present invention. A screen 200 is made up of an operation monitor screen 201 and a transparent sheet 202, which are combined into one for display. The transparent sheet 202 is a transparent virtual sheet put on the operation monitor screen 201. A pattern 203 and a character string 204 are information at the operation time entered and displayed on the transparent sheet 202 (which will be hereinafter called entered information).

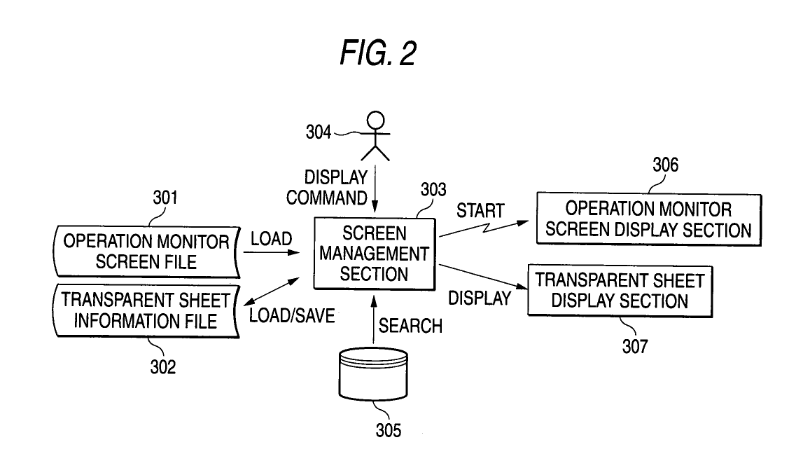

FIG. 2 is a block diagram to show a configuration example of the operation monitor according to the embodiment of the present invention. An operation monitor screen storage section 301 is storage means for retaining the display content of the operation monitor screen 201 as a file. A transparent sheet information storage section 302 is storage means for retaining as a file the entered information 203 and 204 to be displayed on the transparent sheet 202 by a transparent sheet display section 307. A screen management section 303 manages screen display about the screen 200 in response to a command from an operator 304 and issues commands for loading an operation monitor screen file from the operation monitor screen storage section 301, loading and saving a transparent sheet information file from and in the transparent sheet information storage section 302, searching a correspondence information storage section 305, starting an operation monitor screen display section 306, and displaying for a transparent sheet display section 307. The correspondence information storage section 305 retains correspondence information for associating the operation monitor screen file and the transparent sheet information file with each other, for example, in the form of a correspondence table. The operation monitor screen display section 306 displays the contents of the operation monitor screen file sent from the operation monitor screen storage section 301 through the screen management section 303. The transparent sheet display section 307 displays the contents of the transparent sheet information file sent from the transparent sheet information storage section 302 through the screen management section 303 and displays the description of new entered information in the transparent sheet 202 by the operator 304. The screen displayed by the transparent sheet display section 307 is retained as a file in the transparent sheet information storage section 302.

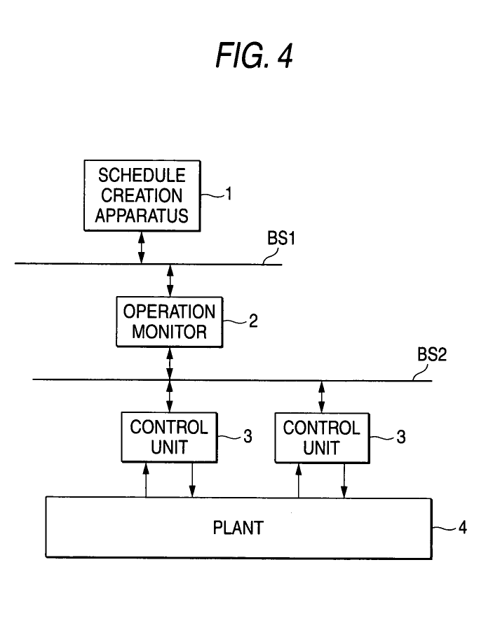

The functions of the sections of the monitor are implemented by a computer in the operation monitor 2 (FIG. 4) and the operation monitor screen storage section 301, the transparent sheet information storage section 302, and the correspondence information storage section 305 are formed in storage of the computer.

In FIG. 1, the operation monitor screen 201 is displayed on the display screen of the operation monitor 2 by the operation monitor screen display section 306 in FIG. 1. The transparent sheet 202 is superposed on the operation monitor screen 201 by the transparent sheet display section 307. The pattern 203 and the character string 204 are entered and displayed on the transparent sheet 202 by the transparent sheet display section 307. The operation monitor screen 201 and the entered information 203, 204 are associated with each other according to the correspondence table in the correspondence information storage section 305 as files provided in a one-to-one correspondence and are retained and managed. The entered information to be retained includes character string information, pattern information, link information with an external file, etc. When information at the operation time is entered in the transparent sheet 202, operation of the operator 304 acts on the transparent sheet 202. When information at the operation time is not entered in the transparent sheet 202, operation of the operator 304 passes through the transparent sheet 202 and acts on the operation monitor screen 201 and therefore usual operation on the operation monitor screen 201 can be continued without being hindered. The operator can switch between information entry required and not required through a keyboard, etc.

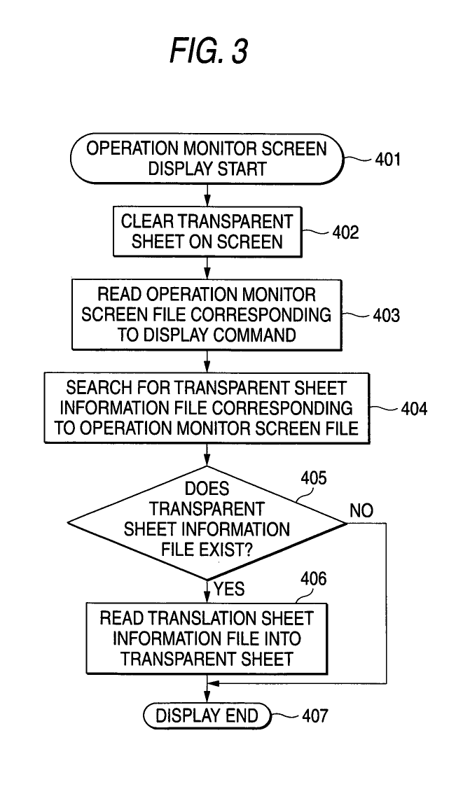

The screen 200 is controlled and is started by the screen management section 303. The display procedure at this time will be discussed below with a flowchart of FIG. 3:

(1) The operator 304 requests the screen management section 303 to display the operation monitor screen 201 (step 401).
(2) The screen management section 303 commands the transparent sheet display section 307 to erase display (step 402).
(3) The screen management section 303 commands the operation monitor screen storage section 301 to search for the operation monitor screen file corresponding to the command from the operator 304 and display the file on the operation monitor screen 201 (step 403).
(4) The screen management section 303 checks whether or not the transparent sheet information file corresponding to the operation monitor screen file exists in the correspondence information storage section 305 (steps 404 and 405).
(5) If the corresponding transparent sheet information file exists, the screen management section 303 commands the transparent sheet display section 307 to display the transparent sheet information file (step 406).
(6) If the corresponding transparent sheet information file does not exist in (4) or after the processing in (5) is complete, the display processing is terminated (step 407).

According to the operation monitor of the configuration as described above, the operation monitor screen and the operation information can be associated with each other in a one-to-one correspondence, so that appropriate information can be provided.

Since the operation information is displayed directly on the operation monitor screen, information can be communicated reliably.

Since the operator can directly view the operation information on the operation monitor screen, the operator can enter and view information in an intuitive manner.

The operation information is electronized and is managed by the screen management section and thus is not lost.

Since the operation information is electronized, it is made possible to search for and reuse the operation information.

Display of the operation information is implemented as a separate screen corresponding to the operation monitor screen, so that information can be added without modifying the operation monitor screen program. Therefore, information can be entered in and viewed on not only the operation monitor screen of the product of the company, but also the product of any other company.

In the example described above, a function of enabling two or more operators to share operation information is implemented, whereby a knowledge information management system can be constructed. Accordingly, a skilled hand can inform an unskilled operator of matters to be noted in operation.

Operation information suited to the operation state of the operator is output from an external program, whereby a navigation system can be constructed.

The invention can be applied not only to the distributed control system, but also to other various production control systems.

A plurality of entered information files for the same operation monitor screen may be provided. In this case, for example, the entered information can be switched between a usual state and an abnormal state.

What is claimed is:

1. An operation monitor for performing control operation and monitoring of a plant through an operation monitor screen, said operation monitor comprising:
a transparent sheet display section for superposing and displaying a transparent sheet and entered information entered on the transparent sheet on the operation monitor screen; and
a storage section for retaining an operation monitor screen file, an entered information file, and correspondence information between the operation monitor screen file and the entered information file.

2. The operation monitor as claimed in claim 1 further comprising:
a screen management section for sending the entered information file corresponding to the operation monitor screen file based on the correspondence information to said transparent sheet display section.

3. The operation monitor as claimed in claim 1 wherein the correspondence information is a correspondence table between the entered information file and the operation monitor screen file.

4. The operation monitor as claimed in claim 1 wherein when information is entered in the transparent sheet, operation of an operator acts on the operation monitor screen.

5. The operation monitor as claimed in claim 1 wherein the entered information is at least any of a character string, pattern information, or link information.

6. The operation monitor as claimed in claim 1 wherein the operation monitor screen file includes display content of the operation monitor screen, and the entered information file includes the entered information to be entered and displayed on the transparent sheet.
